(19) United States
(12) Patent Application Publication
(10) Pub. No.: US 2016/0236805 A1
(43) Pub. Date: Aug. 18, 2016

(54) LABELING DEVICE

(71) Applicant: STARLINGER & CO GESELLSCHAFT M.B.H., Wien (AT)

(72) Inventors: Peter SKOPEK, Klosterneuburg (AT); Norbert NEUMÜLLER, Weissenbach/Triesting (AT)

(21) Appl. No.: 15/024,699

(22) PCT Filed: Oct. 1, 2014
(86) PCT No.: PCT/EP2014/071078

§ 371 Date: Mar. 24, 2016

(30) Foreign Application Priority Data
Oct. 8, 2013 (AT) 13187653.4

(51) Int. Cl. B65C 9/18; B65C 9/42

(52) U.S. Cl. CPC B65C 9/188; B65C 9/42

(57) ABSTRACT

A labeling device for applying labels onto a material web, which is moved in a transport direction at a web speed, comprises a label dispenser and a transferring device, which takes over the labels from the label dispenser by means of holding means, moves the labels towards the material web and applies the labels onto the material web at a transfer location. The holding means of the transferring device can be moved in the transport direction and opposite the transport direction in a circulating path at a variable circulating speed, said holding means moving in the transport direction at the web speed when the holding means are located at the transfer location.

The invention relates to a labeling device for applying labels onto a material web, which is moved in a transport direction at a web speed, comprising a label dispenser and a transferring device, which transfers the labels from the label dispenser towards the material web by means of holding means and applies the labels onto the material web at a transfer location.

Such labeling devices are required in numerous industrial-scale production processes. In this context, steadily increasing operational speeds of production plants pose steadily increasing requirements regarding the performance of the labeling devices. In particular when the material webs are moved continuously at high speeds and, simultaneously, labels are applied onto the material webs at large distances, conventional labeling devices seem to reach their limits.

Labels are usually stored on carrier foils. As there are usually no or only small distances between the labels on the carrier foils, these distances have to be adjusted, if required, to larger distances between the labels of the materials to be labeled. This may, for example, be reached by means of a transferring device between the label dispenser and the material web.

DE10228243B4 thus describes a labeling device, in which the self-adhesive labels are moved transversally to the transport direction of the material webs via a label dispenser towards a transport belt, which sucks the labels at the non-adhesive side thereof and moves the labels transversally across the material webs. The label distances are adjusted when dispensing the labels onto the transport belt via the proportion of the speed of the carrier foil to the speed of the transport belt, wherein the conveyor belt as well as the transport belt are run continuously. This type of adjustment, however, is only possible, if the distances of the labels on the conveyor belt and on the packing foil sections are not significantly or by far different from each other. Furthermore, in this well-known labeling device, the labels are supplied transversally to the transport direction, which requires a further device for applying the labels and for the indexed operation of the material web.

By using a vacuum drum as a transferring device between the label dispenser and the material web, a further device for applying the labels onto the material web may be omitted. Such a vacuum drum is described in DE3915987A1. Thereby, self-adhesive labels are transferred from the carrier foil with the non-adhesive side thereof to a vacuum drum, wherein several suction positions are located on the cylindrical shell surface of this vacuum drum. The conveying speed of the conveyor belt, of the vacuum drum and of the articles to be labeled is continuous in this invention, wherein the speed of the conveyor belt is adjusted to the speed of the articles to be labeled. The distances of the labels in this invention are pre-defined via the distances of the labels on the vacuum drum. Larger distances between the labels on the materials to be labeled may herein only be achieved by larger distances of the labels on the conveyor belt and larger distances of the labels on the vacuum drum. This would, on the one side, lead to extremely large diameters of the label supply rolls and very high conveyor belt consumption, and, on the other side, an increase of the label distances would also require replacement of the vacuum drum.

Due to a continuous operation of the label dispenser and the transferring device, the distance between the labels of the conveyor belt and the material web cannot be enlarged significantly or by far, respectively, if the labels have to be moved at the same speed as the material web in order to achieve exact and flawless application of the labels onto the web material.

In the case of label dispensers that are operated in an indexed way, the dispensing speed in the case of high production rates constitutes a limiting factor as the labels cannot be accelerated to the high speeds of material webs. In particular in the case of longitudinal labels, the longitudinal axis of which is arranged transversally to the transport direction and which are applied onto the material web in the transport direction, the dispensing speed is limited by the high mass of the long components and the long labels.

In summary, with continuously running label dispensers, only small distances between the labels may be achieved on a material web; and in the case of discontinuously running label dispensers, no high material web speeds may be achieved.

It is, hence, the task of the invention to apply labels (in particular longitudinal labels with the longitudinal axis thereof transversal to the material web) exactly and without any creases onto a material web, which is continuously moving at a high speed, wherein the distances of the labels are significantly larger upon the application thereof onto the material web than in the stored condition thereof before application, in particular in the stored condition thereof on a conveyor belt.

The present invention solves the task posed by providing a labeling device for applying labels onto a material web, which is moved at a web speed in a transport direction, comprising a label dispenser and a transferring device, which transfers the labels from the label dispenser towards the material web by means of holding means and applies the labels onto the material web at a transfer location, characterized in that the holding means of the transferring device can be moved in a circulating path at a variable circulating speed in the transport direction and opposite the transport direction, said holding means moving in the transport direction at the web speed when the holding means are located at the transfer location.

In order for the transferring device to transfer the labels from the label dispenser without any formation of cracks, tearing, etc., there is provided that the label dispenser dispenses the labels at a dispensing location at a speed in the dispensing direction and that the holding means of the transferring device move at the same speed and in the same direction, when they are located at the dispensing location.

As the circulating speed of holding means may be variably controlled, and in particular the holding means may be accelerated from a lower speed at the dispensing location to a higher speed at the transfer location, smaller distances of the labels may be translated in the labeling device into large distances of the labels at the material web by realizing the speed control of the holding means in a way so that the period of time, which the holding means require for one complete circulation, is the same as the period of time, which the material web requires to move further by the distance between two applied labels.

In a preferred embodiment the transferring device is a rotating cylinder having a rotational axis transversal to the transport direction, wherein the holding means are arranged on the shell surface of the cylinder. As an alternative, the transferring device comprises at least one driven endless belt, on which the holding means are arranged.

The movement of the holding means may preferably be reversed on the circulating path thereof, as this will enable to reverse the transport direction of the material web without having to reverse the label dispenser.

A very fast and reliably controllable operation of the labeling device is realized by the holding means being formed as vacuum suction devices, preferably having adjustable vacuum force. If the labels are formed as one-sided adhesive labels, and if the holding means hold the adhesive labels on the non-adhesive side thereof, it is advantageous for a simple but reliable transfer of the labels from the transferring device onto the material web if the vacuum force, by means of which the holding means hold the adhesive labels, is smaller than the adhesive force between the adhesive side of the adhesive labels and the material web.

The production of one-sided adhesive labels may be realized on-line during the transfer of the labels by means of an adhesive applicator, which is positioned so that it applies an adhesive onto the side of the label facing away from the transferring device.

Using the invention, it is even possible that the label dispenser dispenses the labels with the longitudinal axis thereof transversal to the transport direction, although it is in principle difficult with label dispensers that are driven in an indexed way to achieve high dispensing speeds if longitudinal labels are being dispensed transversally to the transport direction, as the path and the period of time necessary for the acceleration of the label are shorter than with the labels being dispensed with the longitudinal axis thereof in the transport direction.

The smallest distances of the labels in the label dispenser and especially large distances of the labels on the material web can be adjusted when the label dispenser moves the labels in an indexed way, in particular on a conveyor belt, towards the dispensing location.

In order for the labels to be firmly pressed onto the material web by the transferring device, there is further provided that a counter-pressure device opposite to the transferring device, in particular a rotating counter-pressure roll having a rotational axis transversal to the transport direction, is arranged at the transfer location.

In an especially advantageous embodiment the label dispenser comprises a cutting device, which cuts off individual labels from a web-like label material. Using this embodiment, it is possible to change the width of the labels during the continuous operation of the labeling device.

The invention is now described in detail by way of exemplary embodiments in regard to the drawings. In the drawings

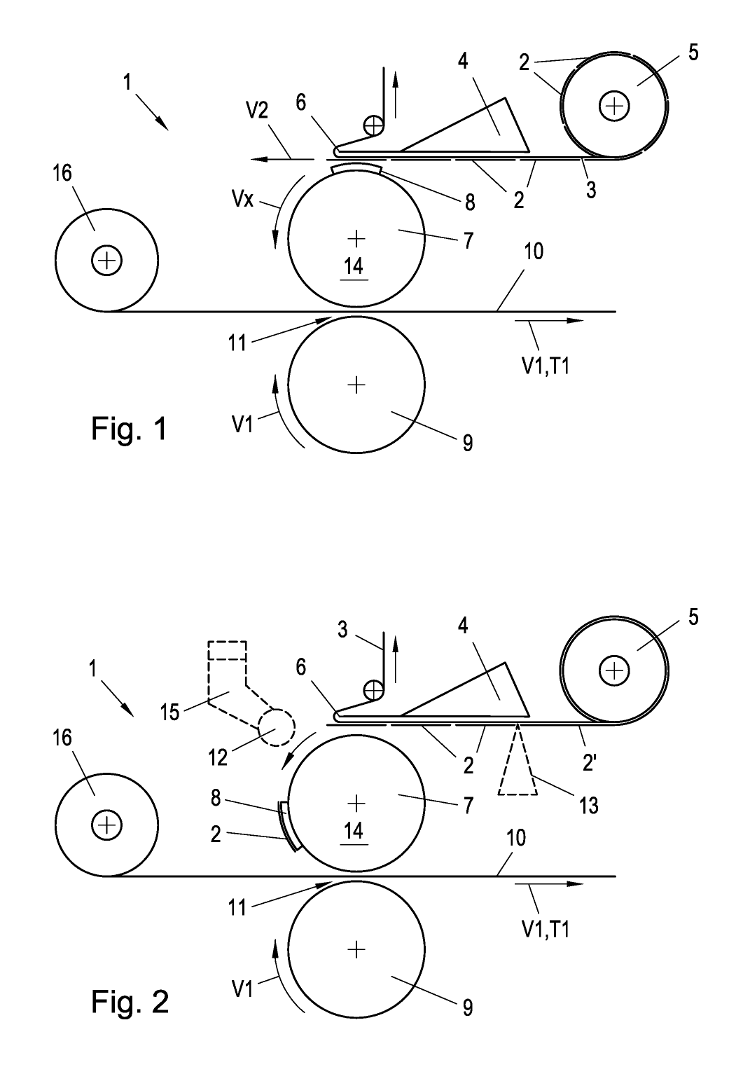

FIGS. 1 to 4 show schematic illustrations of embodiments of the invention in different operational positions; and

FIG. 5 shows a speed/time diagram of the variable speed of the holding means during one circulation of the transferring device.

There is now related to the FIGS. 1 to 3, which schematically show an labeling device 1 according to the invention. The labeling device 1 serves for applying labels 2 onto a material web 10, which is moved in a transport direction T1 at a web speed V1. In order to carry out this task, the labeling device 1 comprises a label dispenser 4 and a transferring device 7, which transfers the labels 2 from the label dispenser 4 towards the material web 10 by means of holding means 8 and applies the labels 2 onto the material web 10 at a transfer location 11. The holding means 8 of the transferring device 7 can be moved in the transport direction T1 and opposite the transport direction in a circulating path at a variable circulating speed Vx, said circulating speed Vx being controlled by a machine control not depicted so that the holding means 8 are moved in the transport direction T1 at the web speed V1 when the holding means are located at the transfer location 11. The label dispenser 4 is operated in an indexed way, with the material web 10 moving continuously at the web speed V1.

In the present embodiment of the labeling device 1 according to the invention, the transferring device 7 is a rotating cylinder having a rotational axis transversal to the transport direction T1, and the holding means 8 are arranged on the shell surface of the cylinder. In this way, the circulating path of the holding means 8 is a circular path, and the circulating speed Vx of the holding means is a result of the speed of rotation of the driven and rotating cylinder. The movement of the cylinder and, hence, of the holding means 8 may be reversed and may be realized clockwise and counter-clockwise. The holding means 8 are formed as vacuum suction devices, preferably having an adjustable vacuum force. The supply of vacuum 14 to the holding means 8 may be realized through the interior of the cylinder.

The label dispenser 4 has a supply roll 5, onto which the—in this example—one-sided self-adhesive labels are wound up adhesively with the adhesive side thereof on a conveyor belt 3. The conveyor belt 3 having the labels 2 is supplied to the label dispenser 4.

In one variant of the invention, which is depicted in FIG. 2 as an option in a dashed line, the labels 2 are non-adhesive labels; there is, however, arranged an adhesive applicator 12 next to the transferring device 7, which applies an adhesive 15 onto the side of the labels 2 facing away from the transferring device 7.

In a further variant of the invention that is also schematically illustrated in FIG. 2, the labels 2 are not stored as individual labels in the supply roll 5 but rather as a web-like label material 2′. The label dispenser 4 has a cutting device 13, which cuts off the individual labels 2 from the web-like label material 2′.

The labels 2 are longitudinal labels, which are, with the longitudinal axis thereof arranged transversally to the transport direction T1, dispensed at a dispensing location 6 of the label dispenser 4 in the transport direction T1. For this purpose, there is required an appropriately wide label dispenser 4 having a wide dispensing location 6. Due to the large mass of the long components of the label dispenser 4 and the longitudinal labels 2, however, the acceleration of the labels during dispensing and, hence, the dispensing speed V2 are limited. In order to increase the speed of the labels 2 from the dispensing speed V2 to the transport speed V1 of the material web 10, the labels 2 are transferred by the holding means 8 of the cylindrical transferring device 7 by one label 2 being sucked at the dispensing location 6 at the non-adhesive side thereof by way of vacuum 14 onto the suction means 8 of the transferring device 7. In order to guarantee an exact transfer of the label 2 to the transferring device 7, it is important that the holding means 8 of the transferring device 7 are passed through the dispensing location 6 at the same speed as at which the label is being dispensed.

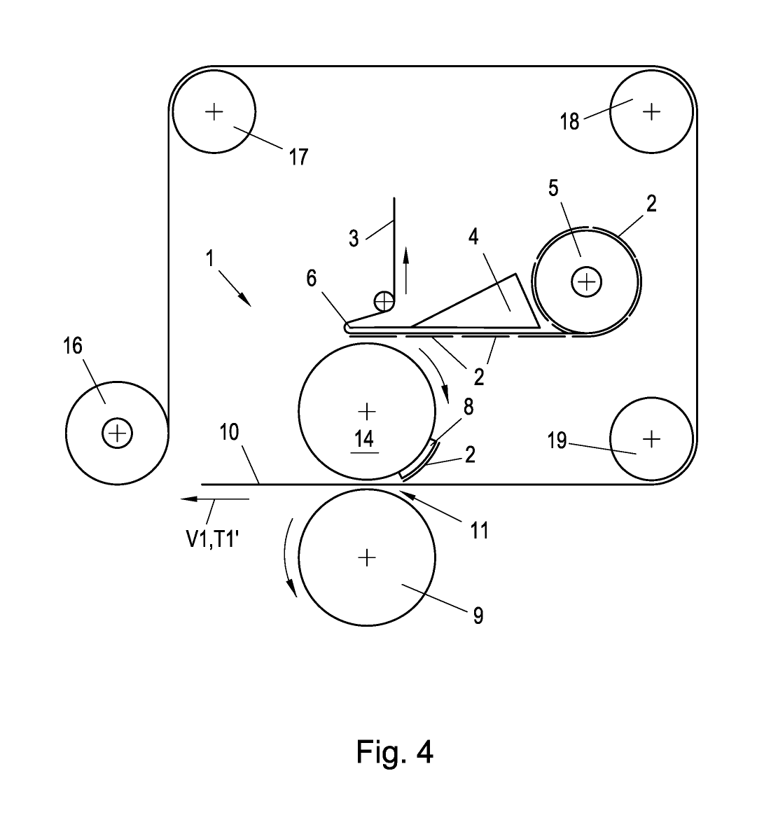

In FIG. 4, the material web 10 is supplied via rolls 17, 18, 19 in the transport direction T1′ towards the transfer location 11. In this way, labels 2 can also be applied onto the rear side of the material web 10. For this purpose, the transferring device 7 is moved through the label dispenser at the dispensing speed V2 opposite the transport direction T1′ (in the dispensing direction). If a label has been transferred by the holding means 8, then the direction of movement is reversed and the label is transferred at the transfer location in the transport direction T1′ at the web speed V1 onto the rear side of the material web.

FIG. 5 shows a diagram of the varying speed Vx of the rotating holding means 8 versus the period of time t for a complete circulation of the cylinder-like transferring device 7. The section A shows the status, in which the holding means 8 are moved through the dispensing location 6 at the dispensing speed V2.

If the label is now located at the suction means 8 of the transferring device 7, then the cylinder has to be accelerated to the transport speed V1 of the continuously moved material web 10 in order for the label 2 being applied with the adhesive side thereof onto the material web 10 in an exact and crease-free way. This process of acceleration corresponds to the section B of the speed/time diagram of FIG. 5. The corresponding position of the holding means 8 is shown in FIG. 2. The vacuum force/suction force has to hold the label during the process of acceleration at the holding means 8; it is, however, to be smaller than the adhesive force of the label 2, so that the label may be applied at the transfer location 11 onto the material web. There is further conceivable control or position-controlled switch on/off of the suction force.

When the holding means 8 reach the transfer location 11, they have already been accelerated to the transport speed V1, moving constantly at the transport speed V1, as is visible in section C of the speed diagram of FIG. 5. In order to achieve a better pressing force of the labels 2 onto the material web 10, the material web 10 is supported in the area of the transfer location 11 by a counter-pressure device 9, in this embodiment a counter-pressure roll rotating at the transport speed V1 with a rotational axis transversal to the transport direction T1.

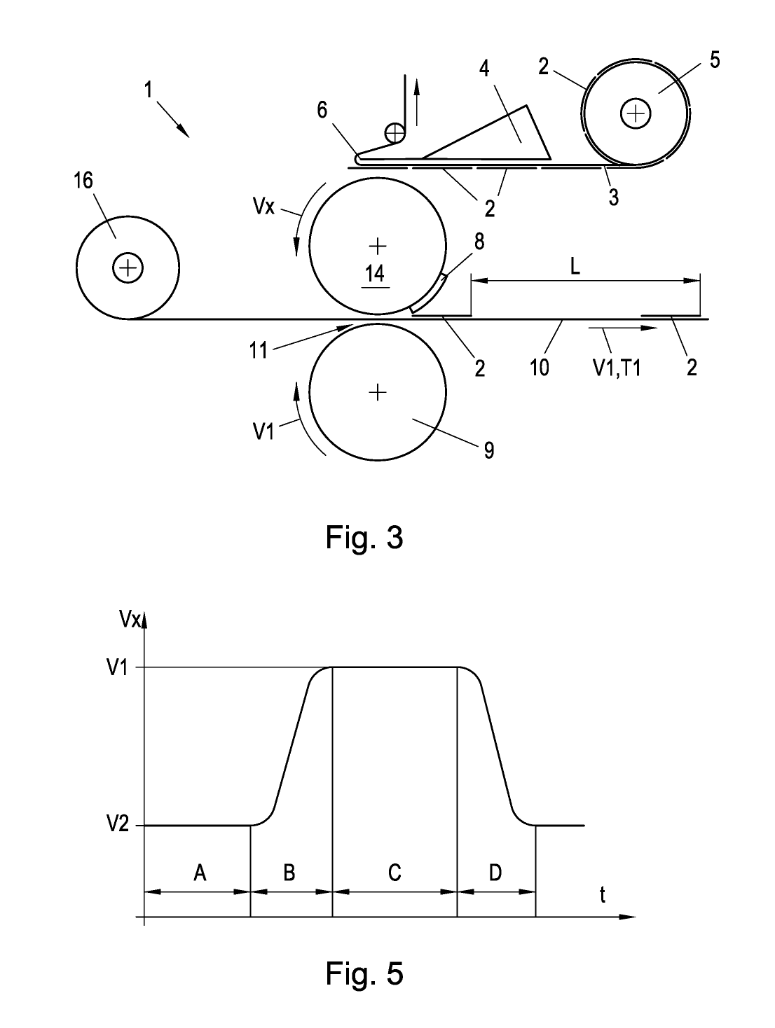

After the label 2 has been applied onto the material web 10 at the transfer location 11, the holding means 8 are decelerated to the dispensing speed V2 by decelerating the rotational speed of the cylindrical transferring device 7, as is visible in section D of the speed diagram of FIG. 5. The corresponding position of the holding means 8 is depicted in FIG. 3. All sections A, B, C and D together describe a complete circulation of the holding means 8. In summary, the variable circulating speed Vx of the holding means 8 is controlled so that the period of time, which the holding means 8 require for a complete circulation, is the same as the period of time, which the material web 10 requires to move further by the distance L between two applied labels 2, 2.

As the cylindrical transferring device 7 may be reversibly rotated clockwise and counter-clockwise, it is also possible to pick up a label 2 in the depicted dispensing direction and, as soon as the label adheres to the holding means 8, to move the transferring device 7 in the opposite direction. Even in the case of the direction of movement T1 of the material web 10 being changed, this will provide for dispensing labels 2, without having to reverse the orientation of the label dispenser 4.

Due to the electronic speed control of the cylindrical transferring device 7, the distances L (see FIG. 3) between the labels 2 on the material web 10 may be changed at any point of time, without having to modify the labeling device 1 by replacement of cylindrical transfer devices having different diameters. Conventional and continuously running vacuum cylinders have to be replaced in the case of changing label distances, which naturally will lead to a delay in the production process.

Due to speed control it is further possible to install cylindrical transferring devices 7 having small diameters, which will lead to savings in regard to space and mass. The smaller the mass of the cylinder, the lower the mass moment of inertia, making it possible to achieve higher accelerations. The mass of the cylinder may be kept rather small by materials such as, e.g., carbon fiber plastic materials. Another advantage of cylinders having a small diameter is that the centrifugal force acting on the labels 2 is smaller at the same circulating speed for cylinders having a small diameter than cylinders having a large diameter. In this way, there is required less suction force in the case of small cylinders in order to hold the labels at the holding means 8.

By supplying longitudinal labels 2 with the longitudinal axis thereof transversal to the transport direction T1, the number of labels 2 that may be stored is essentially higher with the same diameter of the supply roll 5 than with labels, which are arranged with the longitudinal axis thereof in parallel to the material web 10. In this way, production needs to be discontinued less frequently for a replacement of the supply roll 5, thus increasing the efficiency of the labeling device 1.

In an alternative embodiment of the labeling device 1 that is not depicted, the transferring device 7 may comprise at least one driven endless belt, on which the holding means 8 are arranged.

The labeling device according to the invention may be especially well used in plants for the production of bags having a folded bottom, in which longitudinal labels are applied, e.g., for reinforcement of a weakening of the material (e.g., Easy Open Feature), or which serve as a bag edge reinforcement.

The labeling device according to the invention may process non-adhesive labels (using the optional adhesive applicator), self-adhesive labels as well as labels having a pressure-sensitive adhesive or hot-melt, respectively. Different label distances may be adjusted according to the requirements of the material webs (e.g., in the case of different rapport lengths of bag bodies) simply by regulating the circulating speed of the holding means at the transferring device. Furthermore, there may be used print marks as a signal for the speed regulation of the transferring device in order to determine the position of the labels.

The supply roll for the labels needs not to be positioned within the label dispenser but may be arranged, e.g., laterally next to the machine frame or installed within the machine.

1. A labeling device (1) for applying labels (2) onto a material web (10), which is moved in a transport direction (T1) at a web speed (V1), comprising a label dispenser (4) and a transferring device (7), which takes over the labels (2) from the label dispenser (4) by means of holding means (8), moves the labels (2) towards the material web (10) and applies the labels (2) onto the material web (10) at a transfer location (11), characterized in that the holding means (8) of the transferring device (7) can be moved in a circulating path at a variable circulating speed (Vx) in the transport direction (T1) and opposite the transport direction, said holding means (8) moving in the transport direction (T1) at the web speed (V1) when the holding means are located at the transfer location (11).

2. A labeling device according to claim 1, characterized in that the label dispenser (4) dispenses the labels (2) at a dispensing location (6) at a dispensing speed (V2) and that the holding means (8) of the transferring device (7) move at the same speed as the dispensing speed (V2) when the holding means are located at the dispensing location (11).

3. A labeling device according to claim 1 or 2, characterized in that the variable circulating speed (Vx) of the holding means (8) is controlled so that the period of time, which the holding means (8) require for an entire circulation, is equal to the period of time, which the material web (10) requires to move further by the distance (L) between two applied labels (2, 2).

4. A labeling device according to any of the preceding claims, characterized in that the transferring device (7) is a rotating cylinder having a rotational axis transversal to the transport direction (T1) and that the holding means (8) are arranged on the shell surface of the cylinder.

5. A labeling device according to any of claims 1 to 3, characterized in that the transferring device (7) comprises at least one driven endless belt, on which the holding means (8) are arranged.

6. A labeling device according to any of the preceding claims, characterized in that the movement of the holding means (8) on the circulating path thereof may be reversed.

7. A labeling device according to any of the preceding claims, characterized in that the holding means (8) are formed as vacuum suction devices, preferably having adjustable vacuum force.

8. A labeling device according to claim 7, wherein the labels (2) are formed as one-sided adhesive labels and wherein the holding means (8) hold the adhesive labels on the non-adhesive side thereof, characterized in that the vacuum force, by means of which the holding means (8) hold the adhesive labels, is smaller than the adhesive force between the adhesive side of the adhesive labels and the material web (10).

9. A labeling device according to any of the preceding claims, characterized by an adhesive applicator (12) for applying adhesive onto the side of the labels (2), which faces away from the transferring device (7).

10. A labeling device according to any of the preceding claims, characterized in that the labels (2) are longitudinal labels and that the label dispenser (4) dispenses the labels with the longitudinal axis thereof transversal to the transport direction (T1).

11. A labeling device according to any of claims 1 to 10, characterized in that the label dispenser (4) moves the labels (2) in an indexed way, in particular on a conveyor belt (3), towards the dispensing location (6).

12. A labeling device according to any of the preceding claims, characterized in that there is arranged, at the transfer location, a counter-pressure device (9) opposite to the transferring device (7), in particular a rotating counter-pressure roll having a rotational axis transversal to the transport direction (T1).

13. A labeling device according to any of the preceding claims, characterized in that the label dispenser comprises a cutting device (13), which cuts individual labels (2) off from a web-like label material.
